(19) United States
(12) Patent Application Publication
(10) Pub. No.: US 2015/0199111 A1
(43) Pub. Date: Jul. 16, 2015

(54) GUI SYSTEM, DISPLAY PROCESSING DEVICE, AND INPUT PROCESSING DEVICE

(71) Applicant: CASIO COMPUTER CO., LTD., Tokyo (JP)

(72) Inventor: Takeshi OKADA, Tokyo (JP)

(73) Assignee: CASIO COMPUTER CO., LTD., Tokyo (JP)

(21) Appl. No.: 14/596,868

(22) Filed: Jan. 14, 2015

(30) Foreign Application Priority Data
Jan. 16, 2014 (JP) 2014-005539

(51) Int. Cl. G06F 3/0481; G06F 3/041; G06F 3/01; G06K 9/00

(52) U.S. Cl. CPC G06F 3/04817; G06K 9/00604; G06F 3/041; G06F 3/013

(57) ABSTRACT

A GUI system includes a display processing device that has a display unit, a first processing unit configured to cause the display unit to display a screen including an icon, and a gaze direction detection unit configured to detect a gaze direction of a user, and an input processing device that has a second processing unit capable of communicating with the first processing unit, the second processing unit being configured to identify an operation, and an operation transmission unit configured to transmit the operation identified by the second processing unit to the first processing unit. The first processing unit controls the display processing device based on a location identified by the gaze direction detection unit and the operation transmitted by the operation transmission unit.

### BACKGROUND OF THE INVENTION

The present invention relates to a GUI system, a display processing device, and an input processing device.

### DESCRIPTION OF THE RELATED ART

Wearable computers that can be mounted on users' bodies have been developed. In particular, by applying a head-mounted display to a wearable computer, computer graphics images are formed in front of a user's eyes as virtual images. Thus, a wearable computer that can be mounted on a user's head like eyeglasses is provided.

JP 2004-180208 A and JP 2010-199789 A disclose head-mounted wearable computers that can be operated by gaze input. As described in JP 2004-180208 A and JP 2010-199789 A, these head-mounted wearable computers are provided with a gaze direction detecting device. The gaze direction detecting device is used as a pointing device. Specifically, by detecting a gaze direction with the gaze direction detecting device, a location where a computer screen and a gaze intersect is identified. When an icon or the like in the computer screen coincides with the gaze, the icon is selected.

However, operation only by gaze input does not provide good handleability and operability.

### BRIEF SUMMARY OF THE INVENTION

Thus, a problem to be solved by the present invention is to assist operation by gaze input, thereby improving handleability and operability of computers.

According to an embodiment of the present invention, there is provided a GUI system including a display processing device that has a display unit, a first processing unit configured to cause the display unit to display a screen including an icon, and a gaze direction detection unit configured to detect a gaze direction of a user, and an input processing device that has a second processing unit capable of communicating with the first processing unit, the second processing unit being configured to identify an operation, and an operation transmission unit configured to transmit the operation identified by the second processing unit to the first processing unit, in which the first processing unit controls the display processing device based on a location identified by the gaze direction detection unit and the operation transmitted by the operation transmission unit.

According to an embodiment of the present invention, there is provided a display processing device including a display unit, a processing unit configured to cause the display unit to display a screen including an icon, a gaze direction detection unit configured to detect a gaze direction of a user, thereby identifying a location in the screen displayed on the display unit, and a reception unit configured to receive the content of an operation from an input processing device capable of wirelessly communicating with the processing unit, in which the processing unit controls the display processing device based on the location identified by the gaze direction detection unit and the content of the operation received by the reception unit.

According to an embodiment of the present invention, there is provided an input processing device including an operation unit, a connection unit configured to connect to a display processing device by communication, an identification unit configured to identify an operation of the operation unit based on an output signal from the touch panel, an operation transmission unit configured to transmit the operation on the touch panel identified by the identification unit to the display processing device connected via the connection unit; and a switch unit configured to switch between an input mode in which to identify an operation to the display processing device performed by the operation unit and some other mode, wherein the identification unit identifies an operation based on an output signal from the touch panel when the operation of the operation unit is performed in the input mode.

### BRIEF DESCRIPTION OF THE SEVERAL VIEWS OF THE DRAWING

FIG. 1 is a diagram illustrating a GUI system in a used state according to an embodiment of the present invention;

FIG. 2 is a block diagram of the GUI system;

FIG. 3 is a diagram illustrating an example of a GUI screen displayed on a display unit of a display processing device provided in the GUI system;

FIG. 4 is a diagram illustrating an example of a GUI screen displayed on the display unit of the display processing device;

FIG. 5 is a chart showing the flow of processing performed by a processing unit of the display processing device;

FIG. 6 is a chart showing the flow of processing performed by the processing unit of the display processing device;

FIG. 7 is a diagram illustrating an example of a GUI screen displayed on the display unit of the display processing device;

FIG. 8 is a diagram illustrating an example of a GUI screen displayed on the display unit of the display processing device;

FIG. 9 is a diagram illustrating criteria on which to determine where a gaze direction detected by a gaze direction detection unit of the display processing device is pointed in the screen; and

FIG. 10 is a diagram illustrating an example of a GUI screen displayed on the display unit of the display processing device.

### DETAILED DESCRIPTION OF THE INVENTION

Hereinafter, an embodiment of the present invention will be described with reference to the drawings. However, various limitations technically preferable for implementing the present invention are put on the embodiment described below. These are not intended to limit the technical scope of the present invention to the embodiment and illustrated examples below.

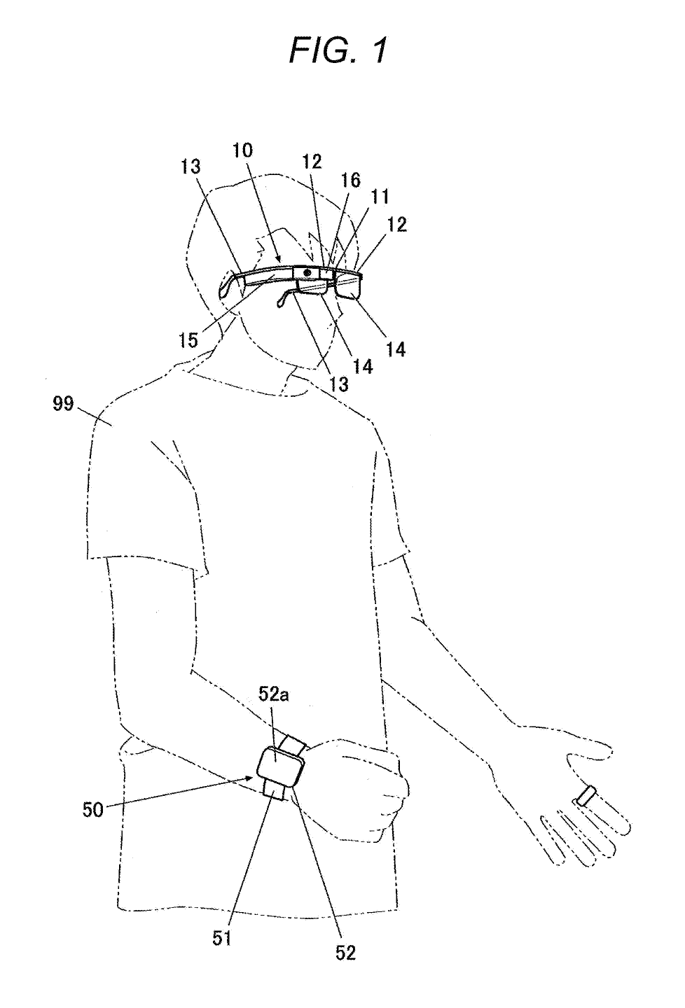

FIG. 1 is a diagram illustrating a graphical user interface system (hereinafter, GUI system) 1 in a used state. The GUI system 1 includes a display processing device 10 and an input processing device 50.

The display processing device 10 is a so-called wearable computer system, or specifically a head-mounted computer system (head-mounted display). More specifically, the display processing device 10 can be mounted on a head like eyeglasses. That is, the display processing device 10 has an eyeglass frame (head-mounted portion) that can be mounted on the head of a user (wearer) 99. The eyeglass frame is composed of a bridge 11, a pair of right and left rims 12, a pair of right and left temples 13, and others. The right and left rims 12 are coupled by the bridge 11. The temples 13 are connected to end portions of the rims 12 by hinges. Ear pads are provided at the temples 13. A pair of right and left nose pads is provided at the bridge 11. Prescription or plain lenses 14 are fitted into the rims 12.

The display processing device 10 includes a main unit 15 and an optical element 16. The main unit 15 is attached below the temple 13. The optical element 16 is provided at the front end of the main unit 15. The optical element 16 is disposed in front of the lens 14. The optical element 16 is a holographic optical element, for example. Light of images of the outside world in front of the user 99 passes through the optical element 16 and reaches a pupil of the user 99. At the same time, light of an image generated by the main unit 15 is introduced (diffracted and reflected) into the pupil of the user 99 by the optical element 16. Therefore, the light of the outside world images and the light of the image are superimposed, and the outside world images and the image are synthesized and reflected in the pupil of the user 99.

The input processing device 50 is a portable computer system, or specifically a wearable computer system. More specifically, the input processing device 50 is a multifunctional high-functionality watch (so-called smartwatch). The input processing device 50 can be mounted on an arm like a wristwatch. That is, the input processing device 50 has a wristband 51 and a main unit 52. The wristband 51 is attached to the main unit 52. The wristband 51 can be fitted on an arm. Alternatively, the input processing device 50 may be a multifunctional high-functionality mobile phone (so-called smartphone).

An electronic circuit board or the like is provided inside the main unit 15 of the display processing device 10. The same applies to the inside of the main unit 52 of the input processing device 50.

The main unit 52 of the input processing device 50 is connected to the main unit 15 of the display processing device 10 by wireless communication. By operating the main unit 52 of the input processing device 50, the main unit 15 of the display processing device 10 can be remotely operated. The standard for wireless communications between the main unit 52 of the input processing device 50 and the main unit 15 of the display processing device 10 is Bluetooth (registered trademark). Some other standard or scheme may alternatively be used.

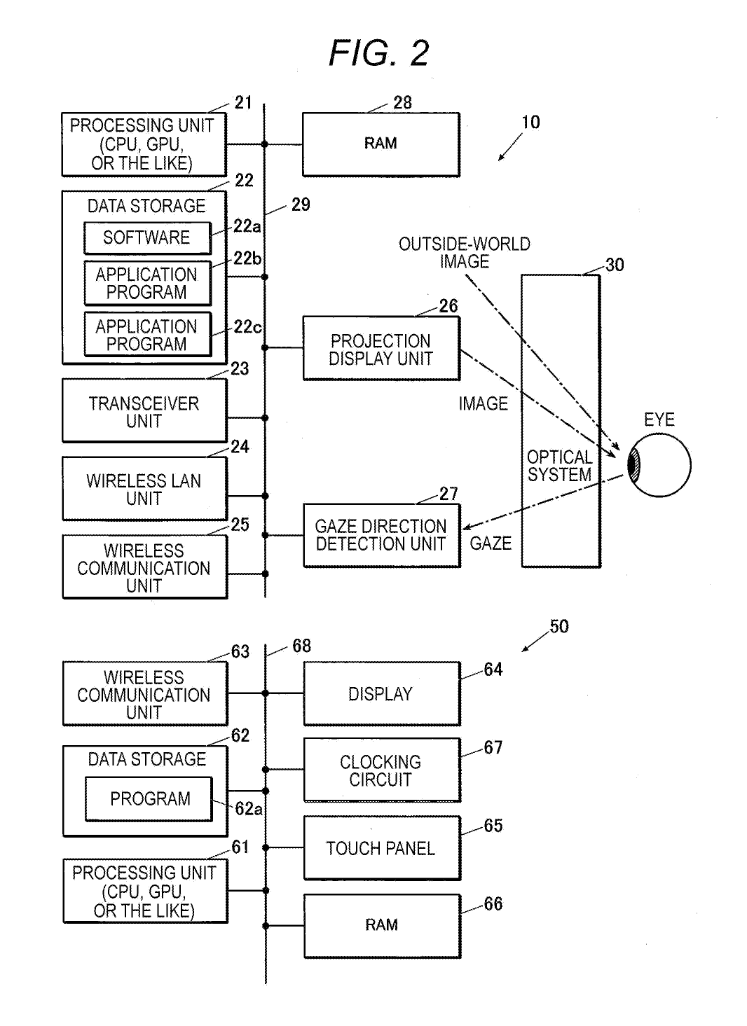

FIG. 2 is a block diagram of the display processing device 10 and the input processing device 50.

The display processing device 10 includes a processing unit (first processing unit) 21, a data storage (auxiliary storage unit) 22, a transceiver unit (portable wireless unit) 23, a wireless LAN unit 24, a wireless communication unit (short-range wireless unit) 25, a projection display unit (display unit) 26, a gaze direction detection unit 27, RAM (main storage unit) 28, a system bus 29, an optical system 30, and others. The processing unit 21, the data storage 22, the transceiver unit 23, the wireless LAN unit 24, the wireless communication unit 25, the projection display unit 26, the gaze direction detection unit 27, the RAM 28, and the system bus 29 are provided on the electronic circuit board in the main unit 15. The optical element 16 (see FIG. 1) is a component of the optical system 30. In addition to that, a projection lens, a taking lens, and others are components of the optical system 30. The projection lens is used in the projection display unit 26, and the taking lens is used in the gaze direction detection unit 27.

A computer of the display processing device 10 is mainly composed of the processing unit 21, the data storage 22, the RAM 28, and the system bus 29. Peripherals of the computer include the transceiver unit 23, the wireless LAN unit 24, the wireless communication unit 25, the projection display unit 26, and the gaze direction detection unit 27. The computer and the peripherals are built in the main unit 15.

The computer of the display processing device 10 is installed with an operating system (hereinafter, referred to as OS) for operating and managing the computer and the peripherals.

The input processing device 50 includes a processing unit (second processing unit) 61, a data storage (auxiliary storage unit) 62, a wireless communication unit (short-range communication unit) 63, a display 64, a touch panel 65, RAM (auxiliary storage unit) 66, a clocking circuit 67, a system bus 68, and others. The processing unit 61, the data storage 62, the wireless communication unit 63, the display 64, the touch panel 65, the RAM 66, the clocking circuit 67, and the system bus 68 are provided on the electronic circuit board in the main unit 52.

A computer of the input processing device 50 is mainly composed of the processing unit 61, the RAM 66, the data storage 62, and the system bus 68. Peripherals of the computer include the wireless communication unit 63, the display 64, the touch panel 65, and the clocking circuit 67. The computer and the peripherals are built in the main unit 52. In particular, the touch panel 65 is placed on top of the display 64, and the touch panel 65 is provided on a front surface 52a of the main unit 52 (see FIG. 1).

The computer of the input processing device 50 is installed with an OS (firmware) for operating and managing the computer and the peripherals.

Next, the units of the display processing device 10 will be described in detail.

The system bus 29 performs data transfer between the processing unit 21, the data storage 22, the transceiver unit 23, the wireless LAN unit 24, the wireless communication unit 25, the projection display unit 26, the gaze direction detection unit 27, and the RAM 28.

The processing unit 21 is composed of a CPU, a GPU, a cache memory, and others.

The RAM 28 is a memory to be a work area of the processing unit 21. Data generated by the processing unit 21 when performing processing is temporarily recorded in the RAM 28.

The data storage 22 is nonvolatile semiconductor memory or a small magnetic storage device.

The transceiver unit 23 performs data communication with mobile phone communication base stations. Specifically, the transceiver unit 23 performs various kinds of processing on data transferred by the processing unit 21, and transmits the data after the processing to a mobile phone communication base station. Also, the transceiver unit 23 receives communication data from a communication base station, performs various kinds of processing on the communication data, and transfers the communication data to the processing unit 21, the RAM 28, the data storage 22, or the like.

The wireless LAN unit 24 performs data communication with an access point or an adapter by a wireless LAN (IEEE 802.11). Specifically, the wireless LAN unit 24 performs various kinds of processing on data transferred by the processing unit 21, and transmits the data after the processing to the access point or the adapter. Also, the wireless LAN unit 24 receives communication data from the access point or the adapter, performs various kinds of processing on the communication data, and transfers the communication data to the processing unit 21, the RAM 28, the data storage 22, or the like.

The wireless communication unit 25 performs data communication based on Bluetooth. Specifically, the wireless communication unit 25 performs various kinds of processing on data transferred by the processing unit 21, and transmits the data after the processing to the wireless communication unit 63 of the input processing device 50. Also, the wireless communication unit 25 receives communication data from the wireless communication unit 63 of the input processing device 50, performs various kinds of processing on the communication data, and transfers the communication data to the processing unit 21, the RAM 28, the data storage 22, or the like.

The projection display unit 26 receives an image signal generated by the processing unit 21, and generates (displays) an image based on the image signal. As an example of the configuration of the projection display unit 26, the projection display unit 26 includes a display controller, a display element (for example, a liquid crystal display element or a spatial light modulation element such as a digital micromirror device), a light source device, and others. The display controller controls the light source device and the display element based on an image signal. The light source device irradiates the display element with primary colors (for example, red light, blue light, and green light). The display element is driven by the display controller whereby light with which the display element is irradiated is subjected to modulation control for each pixel of the display element. Thus, the display element generates an image. When the display element of the projection display unit 26 is a light-emitting display element, the light source device is not provided in the projection display unit 26.

An image generated by the projection display unit 26 (specifically, the display element) is projected into the pupil of the user 99 through the optical element 16 of the optical system 30 and the projection lens.

The gaze direction detection unit 27 is used as a pointing device for inputting location information. Specifically, the gaze direction detection unit 27 detects the direction of the gaze of the user 99 looking into the optical element 16 (direction in which the pupil is pointed), thereby identifying its location in a screen displayed on the projection display unit 26. The gaze direction detection unit 27 outputs a signal indicating the detected gaze direction (location in the screen) to the processing unit 21 through the system bus 29.

For example, the gaze direction detection unit 27 includes an imaging element, an image processing unit, and others. An image of the pupil and the surroundings is formed on the imaging element by the optical element 16 of the optical system 30 and the taking lens. The formed image is imaged by the imaging element, thereby being converted into an electronic image. The electronic image is subjected to image processing by the image processing unit whereby the location of the pupil in the electronic image is detected. A gaze direction based on the detected location of the pupil is calculated by the image processing unit. The gaze direction calculated by the image processing unit corresponds to the location in the screen displayed by the projection display unit 26. An image imaged by the imaging element may be an image based on visible light, or may be an image based on infrared rays.

In the data storage 22, software (basic program) 22a, an application program 22b, and an application program 22c are stored.

The software 22a is intended to implement the OS and the GUI of the OS. The processing unit 21 starts and executes the software 22a whereby the data storage 22, the transceiver unit 23, the wireless LAN unit 24, the wireless communication unit 25, the projection display unit 26, the gaze direction detection unit 27, the RAM 28, and the system bus 29 are controlled by the processing unit 21, and perform data transfer between them.

Also, the software 22a causes the processing unit 21 to implement a communication control function. The processing unit 21 implementing the communication control function controls the wireless communication unit 25 to connect (pair) the wireless communication unit 25 to (with) the wireless communication unit 63 by predetermined authentication processing. This allows the processing unit 21 and the processing unit 61 to communicate wirelessly through the wireless communication units 25 and 63.

The application program 22b is installed in the OS. The application program 22b is executable for the processing unit 21 on the OS. The application program 22b is intended for the gaze direction detection unit 27 and the input processing device 50 to operate the GUI. Thus, the application program 22b is a device driver for the input processing device 50 in the OS.

When the communication control function of the processing unit 21 is implemented by the software 22a, and the processing unit 21 and the processing unit 61 are allowed to communicate wirelessly through the wireless communication units 25 and 63, the application program 22b can be executed by the processing unit 21.

The application program 22c is installed in the OS. The application program 22c is, for example, an application program such as map display software, e-mail software, an Internet browser, a messenger, game software, electronic dictionary software, a word processor, spreadsheet software, presentation software, image editing software, drawing software, a vector graphics editor, or digital camera control software.

The application programs 22b and 22c are downloaded into the data storage 22 by the transceiver unit 23 or the wireless LAN unit 24, and installed in the OS. Alternatively, the application programs 22b and 22c may be stored in the data storage 22 in advance and installed in the OS.

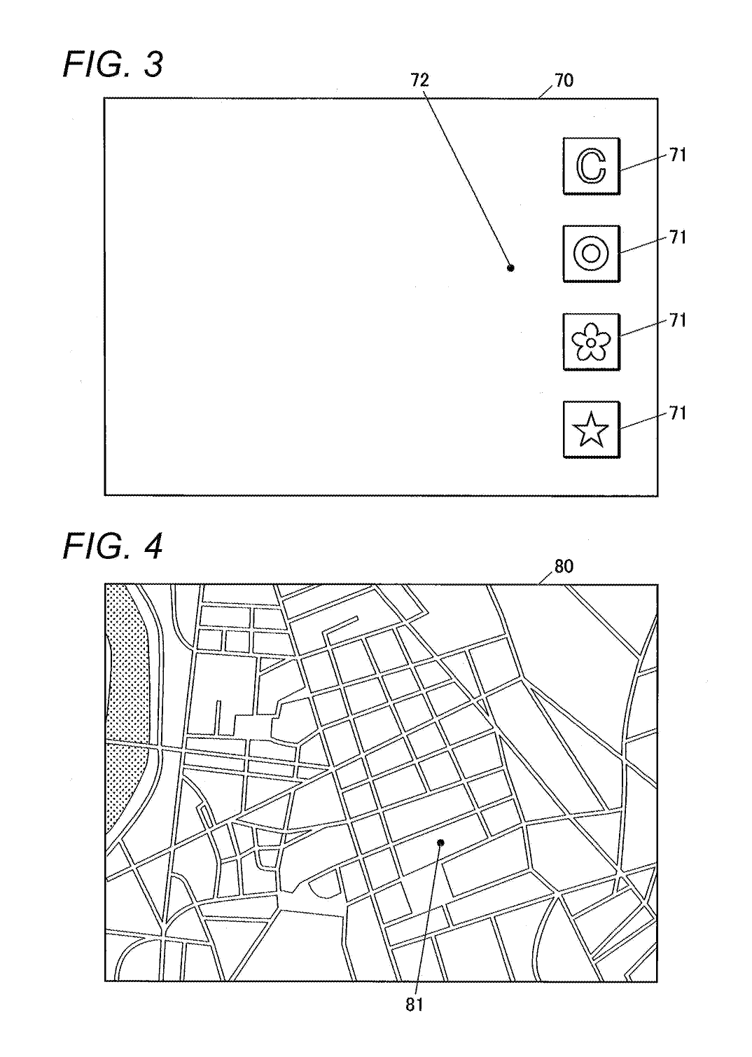

FIG. 3 is an example of a desktop screen displayed by the software 22a causing the processing unit 21 to implement the GUI. A desktop screen 70 shown in FIG. 3 is a screen displayed on the projection display unit 26 by the processing unit 21 controlling the projection display unit 26 according to the software 22a. Specifically, the processing unit 21 generates the desktop screen 70. When the processing unit 21 outputs an image signal in accordance with the desktop screen 70 to the projection display unit 26, the desktop screen 70 shown in FIG. 3 is displayed on the projection display unit 26. The desktop screen 70 displayed on the projection display unit 26 is projected into the pupil of the user 99 by the optical element 16 of the optical system 30 and the projection lens as described above.

When the processing unit 21 generates the desktop screen 70, the processing unit 21 arranges icons 71 in the desktop screen 70, and the processing unit 21 composes the icons 71 with the desktop screen 70. Thus, the icons 71 are displayed on the desktop screen 70 displayed on the projection display unit 26.

Also, when the processing unit 21 generates the desktop screen 70, the processing unit 21 calculates the location of a cursor 72 in the desktop screen 70 from data on a gaze direction detected by the gaze direction detection unit 27, and the processing unit 21 disposes the cursor 72 at the location in the desktop screen 70, and the processing unit 21 composes the cursor 72 at the location. Thus, when the user 99 moves his or her pupils and gaze, data on a corresponding gaze direction is transferred from the gaze direction detection unit 27 to the processing unit 21, so that the cursor 72 seems to move in the desktop screen to the user 99. The transmittance of the cursor 72 is more than 0% to less than or equal to 100%. The cursor 72 may be transparent or translucent. When the cursor 72 is transparent, the cursor 72 is not displayed on the projected desktop screen 70.

One of the icons 71 in the desktop screen displayed on the projection display unit 26 is linked to the application program 22c. By the selection and determination of the icon 71 linked to the application program 22c, the processing unit 21 executes the application program 22c on the software 22a. An application screen 80 as shown in FIG. 4 is displayed on the projection display unit 26.

FIG. 4 is an example of an application screen displayed by the software 22a and the application program 22c causing the processing unit 21 to implement the GUI. When the processing unit 21 generates the application screen 80 by executing the application program 22c and the processing unit 21 outputs an image signal in accordance with the application screen 80 to the projection display unit 26 by the software 22a, the application screen 80 as shown in FIG. 4 is displayed on the projection display unit 26. The application screen 80 displayed on the projection display unit 26 is projected into the pupil of the user 99 through the optical element 16 of the optical system 30 and the projection lens as described above.

The processing unit 21 calculates the location of a cursor 81 in the application screen 80 from data on a gaze direction detected by the gaze direction detection unit 27. The processing unit 21 disposes the cursor 81 at the location in the application screen 80. The processing unit 21 composes the cursor 81 at the location.

Next, the units of the input processing device 50 will be described in detail.

The system bus 68 performs data transfer between the processing unit 61, the data storage 62, the wireless communication unit 63, the display 64, the touch panel 65, the RAM 66, and the clocking circuit 67.

The processing unit 61 is composed of a CPU, a cache memory, and others, and also includes a GPU as necessary.

The RAM 66 is a memory to be a work area of the processing unit 61. Data generated by the processing unit 61 when performing processing is temporarily recorded in the RAM 66.

The data storage 62 is nonvolatile semiconductor memory or a small magnetic storage device.

The wireless communication unit 63 performs data communication based on Bluetooth. Specifically, the wireless communication unit 63 performs various kinds of processing on data transferred by the processing unit 61, and transmits the data after the processing to the wireless communication unit 25 of the display processing device 10. Also, the wireless communication unit 63 receives communication data from the wireless communication unit 25 of the display processing device 10, performs various kinds of processing on the communication data, and transfers the communication data to the processing unit 61, the RAM 66, the data storage 62, or the like.

The clocking circuit 67 is a counter for counting predetermined frequency signals fed from an oscillation circuit, and at the same time adding them to initial time data, thereby keeping current time. The clocking circuit 67 may alternatively be configured to store current time counted in software by the control of the processing unit 21.

The display 64 has a dot-matrix liquid crystal display panel or an organic electroluminescence display panel, and a drive circuit for driving the liquid crystal display panel or the organic electroluminescence display panel. The display 64 displays an image based on an image signal generated by the processing unit 61. The display 64 may alternatively be a segment display.

The touch panel 65 is placed on top of the display surface of the display 64. The touch panel 65 detects the position of contact of a contact object (for example, a finger of the user 99) with the touch panel 65, and generates a signal representing the contact position. An output signal of the touch panel 65 is transferred to the processing unit 61.

The data storage 62 stores a program 62a. The program 62a implements the OS (firmware). The processing unit 61 starts and executes the program 62a whereby the data storage 62, the wireless communication unit 63, the display 64, the touch panel 65, the clocking circuit 67, and the system bus 68 are controlled by the processing unit 61, and also perform data transfer between them.

The program 62a also causes the processing unit 61 to implement a time display function, a communication control function, and a remote operation function.

The processing unit 61 implementing the time display function reads the current time counted by the clocking circuit 67, and causes the display 64 to display the current time so that the current time is shown by characters, symbols, or the like.

The processing unit 61 implementing the communication control function controls the wireless communication unit 63 to connect (pair) the wireless communication unit 63 to (with) the wireless communication unit 25 by predetermined authentication processing. This allows the processing unit 61 and the processing unit 21 to communicate wirelessly through the wireless communication units 63 and 25.

The processing unit 61 has an operation input mode in which to determine the type of operation on the touch panel 65 by the contact object. For example, when the display processing device 10 is in a state to receive a remote operation, the processing unit 61 moves to the operation input mode. In the operation input mode, the time display function of the processing unit 61 may be disabled or may be enabled. When the time display function is disabled, the program 62a may implement a grid display function on the processing unit 61. The processing unit 61 implementing the grid display function causes the display 64 to display a grid.

When the processing unit 61 moves to the mode of operation input to the display processing device 10, the remote operation function of the processing unit 61 is implemented. The processing unit 61 caused to implement the remote operation function determines the type of operation on the touch panel 65 by the contact object based on an output signal from the touch panel 65. Then, the processing unit 61 transfers a command based on the result of the determination (the command is data representing a command to the display processing device 10) to the wireless communication unit 63. The command is transmitted to the wireless communication unit 25 by the wireless communication unit 63.

Next, types of operation on the touch panel 65 and commands will be described in detail.

When an operation on the touch panel 65 is a touch (a touch means that the contact object contacts the touch panel 65 for a short period of time), the processing unit 61 identifies the type of the operation on the touch panel 65 as a touch operation based on an output signal from the touch panel 65. The processing unit 61 transmits a command to the effect that it is a touch (hereinafter, referred to as touch command) to the wireless communication unit 25 via the wireless communication unit 63.

When an operation on the touch panel 65 is a flick (a flick means that the contact object slides along the touch panel 65 with the contact object in contact with the touch panel 65), the processing unit 61 identifies the type of the operation on the touch panel 65 as a flick operation based on an output signal from the touch panel 65. For a period until the contact object is moved off the touch panel 65, the processing unit 61 transmits a command representing a vector of the flick (the direction of the flick and the travel distance per unit time) (hereinafter, referred to as a vector command) to the wireless communication unit 25 via the wireless communication unit 63. When the contact object is moved off the touch panel 65 after the start of the flick operation, the processing unit 61 detects the end of the flick operation based on an output signal from the touch panel 65. The processing unit 61 transmits a command to the effect that the flick operation has ended (hereinafter, referred to as flick end command) to the wireless communication unit 25 via the wireless communication unit 63. When the contact object is stopped without being moved off the touch panel 65 after the start of the flick operation, the vector (travel distance) of a vector command becomes zero.

When the contact object is brought into contact with the touch panel 65, the processing unit 61 identifies the contact of the contact object with the touch panel 65 based on an output signal from the touch panel 65. The processing unit 61 transmits a command representing the contact (hereinafter, contact command) to the wireless communication unit 25 via the wireless communication unit 63 for a period until the contact object is moved off the touch panel 65. On the other hand, when the contact object is not brought into contact with the touch panel 65, the processing unit 61 determines the non-contact of the contact object with the touch panel 65 based on an output signal from the touch panel 65, and does not transmit a contact command.

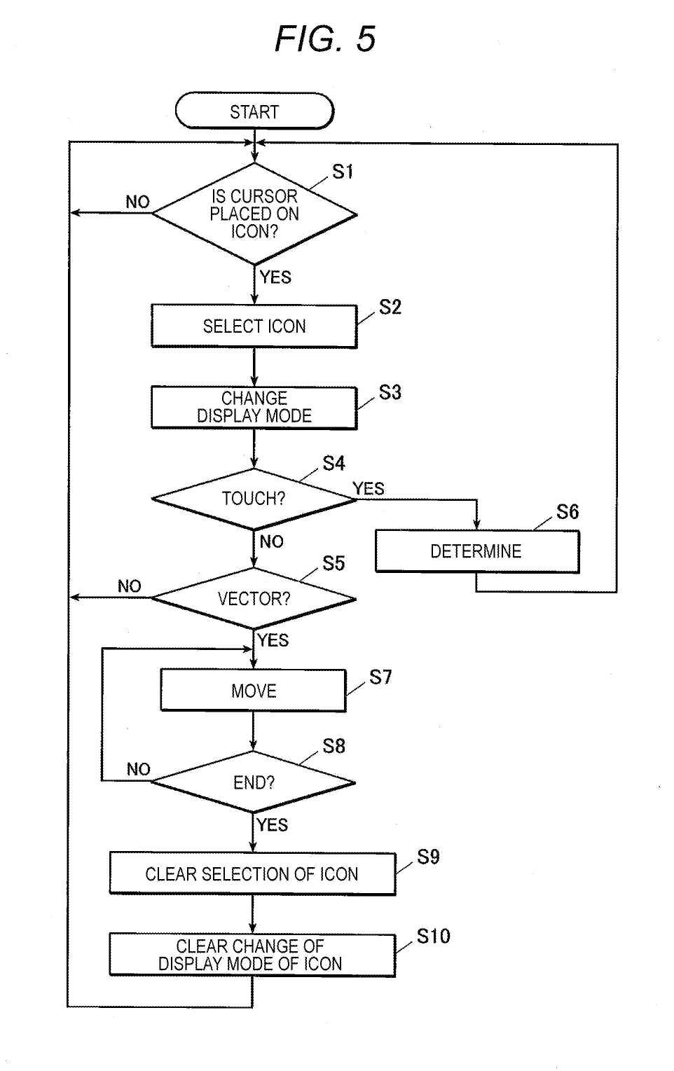

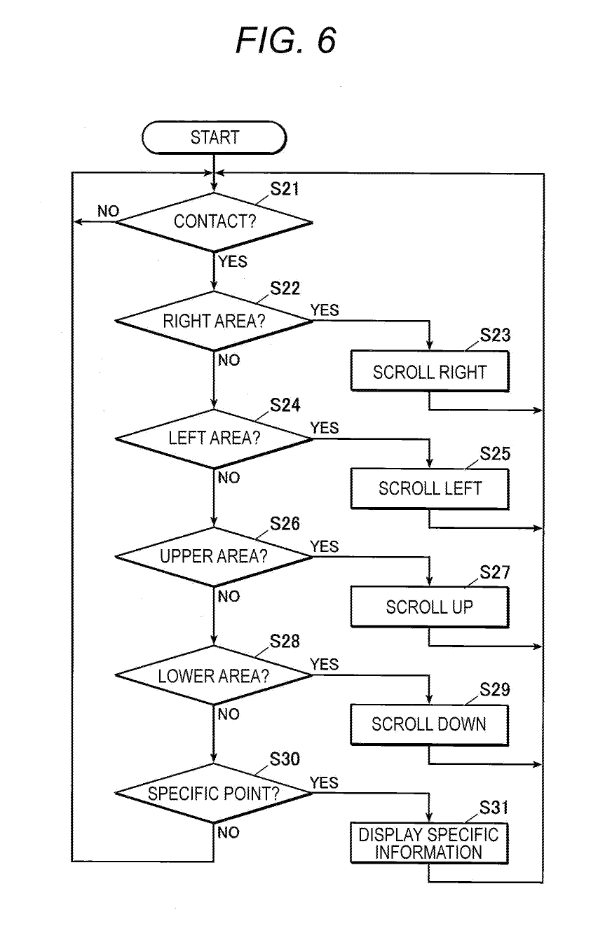

Next, with reference to FIGS. 5 and 6, the flow of processing that the application program 22b causes the processing unit 21 to execute will be described. Here, FIG. 5 shows the flow of processing performed based on the application program 22b when the desktop screen 70 is displayed on the projection display unit 26. FIG. 6 shows the flow of processing performed based on the application program 22c when the application screen 80 is displayed on the projection display unit 26.

The processing shown in FIG. 5 is executed by the processing unit 21 based on the application program 22b when the desktop screen 70 is displayed through the GUI. When an application program other than the application program 22b (for example, the application program 22c) is executed to display its application screen (the application screen 80 for the application program 22c), the processing shown in FIG. 5 is suspended. Thereafter, when the application program is terminated or suspended and the desktop screen 70 is displayed again, the processing unit 21 proceeds with the processing shown in FIG. 5 for execution.

The processing shown in FIG. 5 will be described.

First, the processing unit 21 determines whether or not the cursor 72 in the desktop screen 70 is placed on one of the icons 71 (step S1). Specifically, the processing unit 21 determines whether or not data on a gaze direction detected by the gaze direction detection unit 27 (position of the cursor 72) is included in the display area of one of the icons 71 in the desktop screen 70 (step S1). Here, the processing unit 21 performs the following determination processing on all of the icons 71 in the desktop screen 70.

When the data on the gaze direction detected by the gaze direction detection unit 27 is not included in the display area of one of the icons 71 in the desktop screen 70 (step S1: NO), the processing unit 21 repeatedly executes the processing in step S1. That is, unless the gaze of the user 99 is directed to one of the icons 71 in the desktop screen 70, the processing in step S1 is executed repeatedly.

On the other hand, when the data on the gaze direction detected by the gaze direction detection unit 27 is included in the display area of one of the icons 71 in the desktop screen 70 (step S1: YES), the processing of the processing unit 21 moves to step S2. In step S2, the processing unit 21 selects the icon 71 on which the cursor 72 is placed. Therefore, when the gaze of the user 99 is directed to one of the icons 71 in the desktop screen 70 in step S1, that icon 71 is selected.

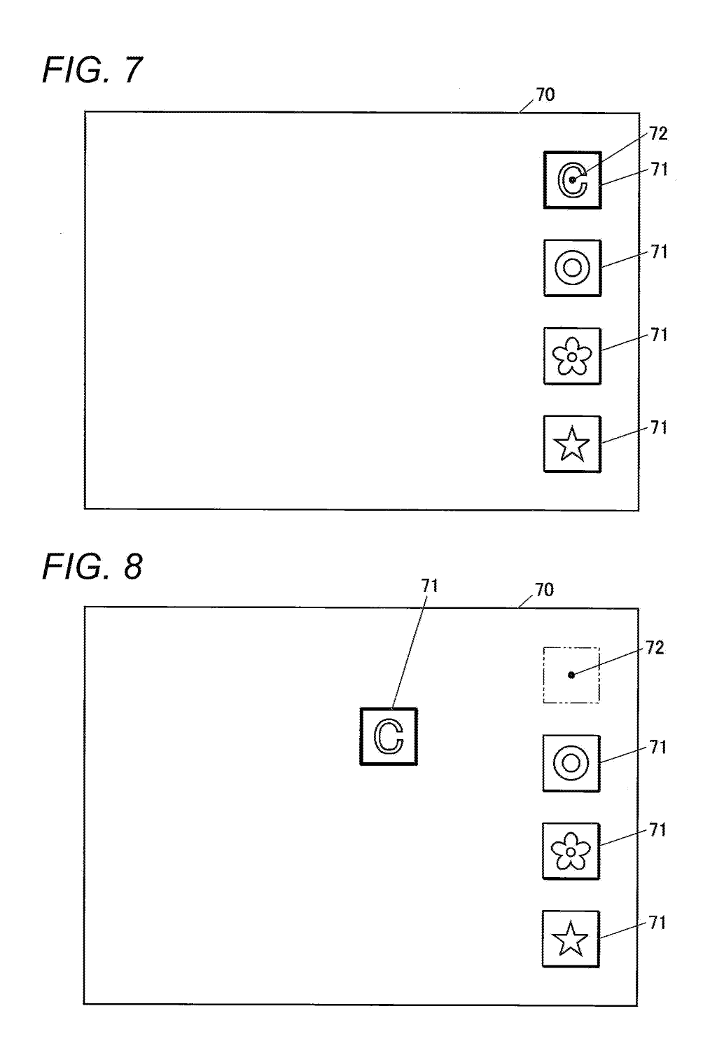

In next step S3, the processing unit 21 changes the display mode of the icon 71 on which the cursor 72 is placed without changing the display position of the icon 71 (see FIG. 7). Therefore, when the gaze of the user 99 is directed to one of the icons 71 in the desktop screen 70 in step S1, the display mode of that icon 71 is changed. Examples of change in display mode include highlighting the icon 71, displaying the icon 71 more transparently by increasing the transmittance of the icon 71, filling the background of the icon 71 with a specific color, displaying the icon 71 in an enlarged view, changing the icon 71 from color to grayscale, reversing the color of the icon 71, and others.

When the display mode of the icon 71 on which the cursor 72 is placed is changed, the processing unit 21 determines whether or not a touch command is received by the wireless communication unit 25 (step S4), and at the same time determines whether or not a vector command is received by the wireless communication unit 25 (step S5). When the processing unit 21 does not receive either a touch command or a vector command (step S4: NO, step S5: NO), the processing of the processing unit 21 moves to step S1.

Therefore, when the user 99 keeps an eye on one of the icons 71 without moving the gaze of the user 99 and without touching the touch panel 65 of the input processing device 50 after the gaze of the user 99 is directed to the icon 71 in the desktop screen 70, processing in step S1 (YES), step S2, step S3, step S4 (NO), and step S5 (NO) is executed repeatedly in this order. Thus the selected state and the changed state in display mode of the icon 71 are maintained. When the user 99 shifts his or her gaze from the icon 71 in the desktop screen 70 while the selected state and the changed state in display mode of the icon 71 are maintained, the processing of the processing unit 21 does not move from step S1 to step S2 (see step S1: NO). Thus the selected state and the changed state in display mode of the icon 71 are cleared. The icon 71 is deselected, and the display mode of the icon 71 returns to the original one.

Here, when the display mode of the icon 71 on which the cursor 72 is placed is changed, information showing that is transmitted by the wireless communication unit 25 to the wireless communication unit 63 of the input processing device 50. When the input processing device 50 receives the information showing that the display mode of the icon 71 is changed via the wireless communication unit 63, it moves to the operation input mode in which to remotely operate the display processing device 10.

When the user 99 touches the touch panel 65 of the input processing device 50 with the gaze of the user 99 directed to the icon 71 in the desktop screen 70, the processing unit 61 identifies the type of the operation on the touch panel 65 as a touch operation based on an output signal from the touch panel 65, and transmits a touch command to the wireless communication unit 25 via the wireless communication unit 63. Then, the processing of the processing unit 21 moves from step S4 to step S6 (step S4: YES). In step S6, the processing unit 21 determines the selection of the icon 71 selected in step S2. When the selected and determined icon 71 is linked to the application program 22c, the processing unit 21 executes the application program 22c.

When the user 99 flicks the touch panel 65 of the input processing device 50 with the gaze of the user 99 directed to the icon 71 in the desktop screen 70, the processing unit 61 identifies the type of the operation on the touch panel 65 as a flick operation based on an output signal from the touch panel 65, and transmits a vector command to the wireless communication unit 25 via the wireless communication unit 63. Then, the processing of the processing unit 21 moves from step S5 to step S7 (step S5: YES). In step S7, the processing unit 21 moves the icon 71 selected in step S2 in the desktop screen 70 according to a vector of the vector command. The display mode of the moved icon 71 may be in a changed state, or may be returned to the original one, or may be further changed into a different mode.

After step S7, the processing unit 21 determines whether or not a flick end command is received by the wireless communication unit 25 (step S8). When the processing unit 21 does not receive a flick end command (step S8: NO), the processing of the processing unit 21 moves to step S7. When the processing unit 21 receives a flick end command (step S8: YES), the processing of the processing unit 21 moves to step S9.

Therefore, when the user 99 does not end the flick on the touch panel 65 of the input processing device 50 after the gaze of the user 99 is directed to the icon 71 in the desktop screen 70, processing in step S7 and step S8 (No) is executed repeatedly. Thus, as shown in FIG. 8, the icon 71 keeps moving in the desktop screen 70 (step S7), and the selected state of the icon 71 is maintained.

Even when the gaze of the user 99 shifts from the icon 71 in the desktop screen 70 during the flick operation on the touch panel 65 of the input processing device 50, the processing in step S7 and step S8 (No) is executed repeatedly. Thus the icon 71 keeps moving in the desktop screen 70 (step S7), and the selected state of the icon 71 is maintained.

When the user 99 does not move the contact object such as his or her finger off the touch panel 65 after temporarily stopping flicking, a flick end command is not transmitted by the processing unit 61 (step S8: NO). The vector of a vector command in subsequent step S7 is zero, so that the icon 71 in the desktop screen 70 only seems to have temporarily stopped, and the selected state of the icon 71 is maintained. Then, when the user 99 resumes the flicking operation after temporarily stopping flicking, the vector of a vector command in subsequent step S7 is not zero, and thus the movement of the icon 71 in the desktop screen 70 is resumed (see step S7).

On the other hand, when the user 99 ends the flick operation and moves the contact object such as his or her finger off the touch panel 65, the processing unit 61 recognizes the end of the flick operation on the touch panel 65 based on an output signal from the touch panel 65, and transmits a flick end command to the wireless communication unit 25 via the wireless communication unit 63. Therefore, the processing of the processing unit 21 moves from step S8 to step S9 (step S8: YES).

In step S9, the processing unit 21 clears the selection of the moved icon 71. Next, the processing unit 21 clears the change of the display mode of the moved icon 71 to return the display mode of the icon 71 to the original one (step S10). Thereafter, the processing of the processing unit 21 returns to step S1.

Processing shown in FIG. 6 will be described.

When the application screen 80 is displayed through the GUI, the processing unit 21 determines whether or not a contact command is received by the wireless communication unit 25 (step S21). When the processing unit 21 receives contact command data, the processing of the processing unit 21 moves to step S22. When the processing unit 21 does not receive contact command data, the processing of the processing unit 21 returns to step S21.

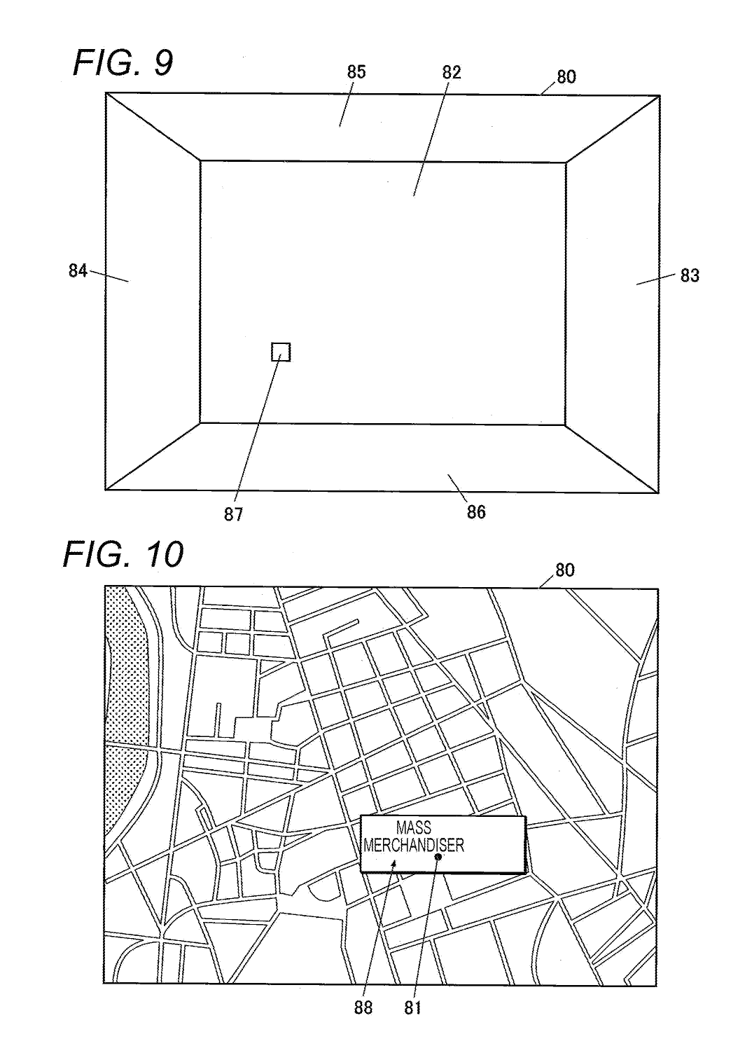

When the processing of the processing unit 21 moves from step S21 to step S22, the processing unit 21 performs processing based on the location of the cursor 81 in the application screen 80 (steps S22 to S30). Specifically, as shown in FIG. 9, the processing unit 21 determines in which area of a right area 83, a left area 84, an upper area 85, and a lower area 86 of a central area 82 in the application screen 80 data on a gaze direction detected by the gaze direction detection unit 27 is located (steps S22, S24, S26, and S28), and at the same time determines whether or not it is located at a specific point 87 in the central area 82 (step S30). Here, FIG. 9 is a diagram that shows criteria on which to determine where the gaze direction is directed in the application screen 80. The central area 82 is an area smaller than the application screen 80, and is an area set at the center of the application screen 80. The right area 83 is an area set on the right side of the central area 82. The left area 84 is an area set on the left side of the central area 82. The upper area 85 is an area set on the upper side of the central area 82. The lower area 86 is an area set on the lower side of the central area 82. The specific point 87 is a position set in the application screen 80 by the processing unit 21 executing the application program 22c.

When the data on the gaze direction detected by the gaze direction detection unit 27 is included in the right area 83 (step S22: YES), the processing unit 21 scrolls the application screen 80 right (step S23). When the data on the gaze direction detected by the gaze direction detection unit 27 is included in the left area 84 (step S24: YES), the processing unit 21 scrolls the application screen 80 left (step S25). When the data on the gaze direction detected by the gaze direction detection unit 27 is included in the upper area 85 (step S26: YES), the processing unit 21 scrolls the application screen 80 up (step S27). When the data on the gaze direction detected by the gaze direction detection unit 27 is included in the lower area 86 (step S28: YES), the processing unit 21 scrolls the application screen 80 down (step S29). When the data on the gaze direction detected by the gaze direction detection unit 27 is located at the specific point (step S30: YES), the processing unit 21 displays specific information (showing information associated with/linked to the specific point by text, graphics, symbols, or the like) 88 on the application screen 80 as shown in FIG. 10 (step S31). The specific information 88 is information obtained by the processing unit 21 executing the application program 22c.

Here, as long as the user 99 keeps his or her finger or the like contacting the touch panel 65 of the input processing device 50, the processing unit 61 continuously detects the contact on the touch panel 65 based on an output signal from the touch panel 65, and continues transmitting contact command data to the wireless communication unit 25 via the wireless communication unit 63. Therefore, when the gaze is directed to the right area 83 while the user 99 touches his or her finger or the like to the touch panel 65 of the input processing device 50, the application screen 80 is scrolled right, when the gaze is directed to the left area 84, the application screen 80 is scrolled left, when the gaze is directed to the upper area 85, the application screen 80 is scrolled up, when the gaze is directed to the lower area 86, the application screen 80 is scrolled down, and when the gaze is directed to the specific point 87, the specific information 88 is displayed on the application screen 80.

When the user 99 moves his or her finger or the like off the touch panel 65 or the user 99 directs his or her gaze to the central area 82 (except the specific point 87, however) while the scroll display or the specific information display is performed, the scroll display or the specific information display is terminated (see step S21: NO, or see steps S22, S24, S26, S28, and S30: NO).

According to the above embodiment, the following advantages or effects are provided.

(1) When the user 99 directs his or her gaze to one of the icons 71 in the desktop screen 70, the display mode of that icon 71 is changed. Thus the user 99 can visually recognize the selection of that icon 71.

(2) When the user 99 touches the touch panel 65 with his or her gaze directed to one of the icons 71 in the desktop screen 70, the selection of that icon 71 is determined. Thus the operation of determining the icon 71 is facilitated. For example, the user 99 can select one of the icons 71, gazing the icon 71.

(3) When the user 99 flicks the touch panel 65 with his or her gaze directed to one of the icons 71 in the desktop screen 70, that icon 71 is moved according to the flicking direction. Thus the icon 71 can be shifted from the gaze direction. That is, the linkage between the icon 71 and the gaze is cleared, so that the user 99 can gaze something other than the icon 71 in the desktop screen 70 while moving the icon 71. Here, the user 99 can see a composite of the desktop screen 70 and outside-world images, so that the user 99 can gaze the outside-world images while moving the icon 71, or do something like that.

(4) When the user 99 directs his or her gaze to a peripheral portion of the application screen 80 while touching the touch panel 65, the application screen 80 is scrolled in that direction, so that the user 99 can intuitively perform the operation of scrolling the screen. On the other hand, when the user 99 releases the touch on the touch panel 65 or directs his or her gaze to the screen central portion during scrolling of the application screen 80, the scrolling is stopped. Thus, the user 99 can intuitively perform the operation of stopping the scrolling of the screen.

(5) When the user 99 directs his or her gaze to the specific point 87 while touching the touch panel 65, the specific information 88 associated with/linked to the specific point 87 is displayed, so that the selection of the specific point 87 and the display of the specific information 88 based on the selection can be easily performed.

Although the embodiment of the present invention has been described above, alterations and modifications of the above-described embodiment are possible to the extent that the principal part of the present invention is not changed. The technical scope of the present invention is not limited to the above-described embodiment, and is defined based on the description of the claims. Further, an equivalent scope to which change unrelated to the essence of the present invention from the description of the claims is added is contained in the technical scope of the present invention.

What is claimed is:

1. A GUI system comprising:
a display processing device including
a display unit,
a first processing unit configured to cause the display unit to display a screen including an icon, and
a gaze direction detection unit configured to detect a gaze direction of a user, and
an input processing device including
a second processing unit capable of communicating with the first processing unit, the second processing unit being configured to identify an operation, and
an operation transmission unit configured to transmit the operation identified by the second processing unit to the first processing unit, wherein
the first processing unit controls the display processing device based on a location identified by the gaze direction detection unit and the operation transmitted by the operation transmission unit.

2. The GUI system according to claim 1, wherein
the first processing unit selects the icon when the location identified by the gaze direction detection unit is the location of the icon in the screen, and
the first processing unit determines the selection of the icon selected by a selection unit, based on the operation transmitted by the operation transmission unit.

3. The GUI system according to claim 2, wherein the first processing unit includes a display mode change unit configured to change the display mode of the icon when the location identified by the gaze direction detection unit is the location of the icon.

4. The GUI system according to claim 2, wherein the first processing unit moves the selected icon in the screen, based on the operation transmitted by the operation transmission unit.

5. The GUI system according to claim 1, wherein the first processing unit further includes a scroll unit configured to scroll the screen in a direction in which the location identified by the gaze direction detection unit is off a central area in the screen when the location identified by the gaze direction detection unit is an area outside the central area in the screen and the operation transmitted by the operation transmission unit is received.

6. The GUI system according to claim 1, wherein the first processing unit displays information associated with a specific point on the screen when the location identified by the gaze direction detection unit is the specific point in the screen and a contact command transmitted by the operation transmission unit is received.

7. The GUI system according to claim 1, wherein
the second processing unit includes a switch unit configured to switch between an input mode in which to identify an operation to the display processing device performed on a touch panel and some other mode, and
the second processing unit identifies an operation on the touch panel based on an output signal from the touch panel when the operation on the touch panel is performed in the input mode.

8. The GUI system according to claim 1, wherein
the input processing device further comprises a touch panel,
the second processing unit identifies an operation on the touch panel based on an output signal from the touch panel, and
the operation transmission unit transmits the operation on the touch panel identified by the second processing unit to the first processing unit.

9. A display processing device comprising:
a display unit;
a processing unit configured to cause the display unit to display a screen including an icon;
a gaze direction detection unit configured to detect a gaze direction of a user, thereby identifying a location in the screen displayed on the display unit; and
a reception unit configured to receive the content of an operation from an input processing device capable of communicating with the processing unit, wherein
the processing unit controls the display processing device based on the location identified by the gaze direction detection unit and the content of the operation received by the reception unit.

10. The display processing device according to claim 9, wherein
the processing unit selects the icon when the location identified by the gaze direction detection unit is the location of the icon in the screen, and
the processing unit determines the selection of the selected icon, based on an operation transmitted by an operation transmission unit.

11. The display processing device according to claim 10, wherein the processing unit changes the display mode of the icon when the location identified by the gaze direction detection unit is the location of the icon in the screen.

12. The display processing device according to claim 9, wherein the processing unit moves the selected icon in the screen, based on the content of the operation received by the reception unit.

13. The display processing device according to claim 9, wherein the processing unit scrolls the screen in a direction in which the location identified by the gaze direction detection unit is off a central area in the screen when the location identified by the gaze direction detection unit is an area outside the central area in the screen and the operation transmitted by an operation transmission unit is received.

14. The display processing device according to claim 9, wherein the processing unit displays information associated with a specific point on the screen when the location identified by the gaze direction detection unit is the specific point in the screen and a contact command transmitted by a transmission unit is received.

15. An input processing device comprising:
an operation unit;
a connection unit configured to connect to a display processing device by communication;
an identification unit configured to identify an operation of the operation unit based on an output signal from the touch panel;
an operation transmission unit configured to transmit the operation on the touch panel identified by the identification unit to the display processing device connected via the connection unit; and
a switch unit configured to switch between an input mode in which to identify an operation to the display processing device performed by the operation unit and some other mode, wherein
the identification unit identifies an operation based on an output signal from the touch panel when the operation of the operation unit is performed in the input mode.
